(19) United States
(12) Patent Application Publication
(10) Pub. No.: US 2021/0316417 A1
(43) Pub. Date: Oct. 14, 2021

(54) COVER AND TOOL

(71) Applicant: MAKITA CORPORATION, Anjo-shi, Aichi (JP)

(72) Inventor: Ryosuke OTANI, Anjo-shi (JP)

(73) Assignee: MAKITA CORPORATION, Anjo-shi, Aichi (JP)

(21) Appl. No.: 17/261,449

(22) PCT Filed: Aug. 1, 2019
(86) PCT No.: PCT/JP2019/030359

§ 371 Date: Jan. 19, 2021

(30) Foreign Application Priority Data
Aug. 6, 2018 (JP) 2018-147789

(51) Int. Cl. B24B 55/10; B24B 23/02; B23Q 11/00

(52) U.S. Cl. CPC B24B 55/102; B23Q 11/0046; B24B 23/02

(57) ABSTRACT

A cover may be used in a tool with a tip tool. The cover may include an inner cover covering at least a part of the tip tool and an outer cover covering at least a part of the inner cover. In the cover, a space between the inner cover and the outer cover may constitute a suction path through which suctioned air flows. In the cover, a shape of the suction path may be changeable by a change in a relative positional relationship between the inner cover and the outer cover.

### TECHNICAL FIELD

The technique disclosed herein relates to a cover and a tool.

### BACKGROUND ART

Japanese Patent Application Publication No. 2010473001 describes a cover used in a tool with a tip tool. This cover covers at least a part of the tip tool. An inner space of the cover constitutes a suction path through which suctioned air flows. By a dust collector connected to the cover suctioning air, the cover collects dust generated by the tip tool processing a workpiece.

### SUMMARY OF INVENTION

### Technical Problem

It may be desired to adjust a suction force of suctioned air in a cover such as above. The disclosure herein provides a technique that enables adjustment of a suction force of suctioned air by a cover used in a tool with a tip tool.

### Solution to Technical Problem

The disclosure herein discloses a cover. The cover may be used in a tool with a tip tool. The cover may comprise an inner cover covering at least a part of the tip tool and an outer cover covering at least a part of the inner cover. In the cover, a space between the inner cover and the outer cover may constitute a suction path through which suctioned air flows. In the cover, a shape of the suction path may be changeable by a change in a relative positional relationship between the inner cover and the outer cover.

The disclosure herein also discloses a tool. The tool may comprise a prime mover; a power transmission mechanism connected to the prime mover; a housing that houses the prime mover and the power transmission mechanism; a tip tool holder configured to hold a tip tool and connected to the power transmission mechanism; and a cover. The cover may include an inner cover covering at least a part of the tip tool and an outer cover covering at least a part of the inner cover. In the tool, a space between the inner cover and the outer cover may constitute a suction path through which suctioned air flows. In the tool, a shape of the suction path may be changeable by a change in a relative positional relationship between the inner cover and the outer cover.

In the cover and the tool described above, the shape of the suction path through which suctioned air flows can be changed by changing the relative positional relationship between the inner cover and the outer cover, thereby flow resistance of the suction path can be changed. As such, the suction force of the suctioned air can be adjusted in the cover.

### BRIEF DESCRIPTION OF DRAWINGS

FIG. 1 shows a perspective view of a grinder 4 seen from front-upper-left side, in a state where a dust collecting cover 2 according to an embodiment is attached thereto.

FIG. 2 shows a longitudinal sectional view of the grinder 4 in the state where the dust collecting cover 2 according to the embodiment is attached thereto.

FIG. 3 shows a perspective view of the dust collecting cover 2 according to the embodiment.

FIG. 4 shows an exploded perspective view of the dust collecting cover 2 according to the embodiment.

FIG. 5 shows a longitudinal sectional view of a front portion of the grinder 4 in the state where the dust collecting cover 2 according to the embodiment attached thereto and no external force is applied to an outer cover 54.

FIG. 6 shows a longitudinal sectional view of the front portion of the grinder 4 in the state where the dust collecting cover 2 according to the embodiment is attached thereto and an external force is applied upward at a front end of the outer cover 54.

### DESCRIPTION OF EMBODIMENTS

Hereinafter, representative, non-limiting examples of the present disclosure will be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved cover's and tools, as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a cover may be used in a tool with a tip tool. The cover may comprise an inner cover covering at least a part of the tip tool and an outer cover covering at least a part of the inner cover. In the cover, a space between the inner cover and the outer cover may constitute a suction path through which suctioned air flows. In the cover, a shape of the suction path may be changeable by a change in a relative positional relationship between the inner cover and the outer cover.

In one or more embodiments, a tool may comprise: a prime mover; a power transmission mechanism connected to the prime mover; a housing that houses the prime mover and the power transmission mechanism; a tip tool holder configured to hold a tip tool and connected to the power transmission mechanism; and a cover. The cover may include an inner cover covering at least a part of the tip tool and an outer cover covering at least a part of the inner cover. In the tool, a space between the inner cover and the outer cover may constitute a suction path through which suctioned air flows. In the tool, a shape of the suction path may be changeable by a change in a relative positional relationship between the inner cover and the outer cover.

In the cover and the tool described above, the shape of the suction path through which suctioned air flows can be changed by changing the relative positional relationship between the inner cover and the outer cover, thereby flow resistance of the suction path can be changed. As a result, it is possible to adjust the suction force of the suctioned air in the cover.

In one or more embodiments, the outer cover may be tiltable in a first direction with respect to the inner cover.

For example, when the outer cover is tilted in the first direction with respect to the inner cover such that one end of the outer cover is farther from the inner cover and another end of the outer cover is closer to the inner cover, the suction path becomes wider near the one end of the outer cover as compared to near the other end of the outer cover, and the flow resistance of the suction path becomes lower there. As such, the suction force near the one end of the outer cover can be increased as compared to the suction force near the other end of the outer cover. The above configuration can locally increase the suction force of the suctioned air in the cover.

In one or more embodiments, the outer cover may be tiltable also in a second direction orthogonal to the first direction with respect to the inner cover.

In a configuration where the outer cover is likable with respect to the inner cover in two directions orthogonal to each other, a position where the outer cover is farthest from the inner cover and the width of the suction path is widest, that is, a position where the flow resistance of the suction path is the lowest can be set to any circumferential position. The above configuration can increase the suction three at any circumferential position as compared to at other positions.

In one or more embodiments, the cover may further comprise an elastic member configured to bias the outer cover by an elastic restoring force such that a tilt angle of the outer cover with respect to the inner cover is reduced when the outer cover tilts with respect to the inner cover.

According to the above-described configuration, it is possible to automatically restore, by using the elastic restoring force of the elastic member, the suction force of suctioned air that has been changed by tilting the outer cover with respect to the inner cover to the suction force of suctioned air at when the outer cover is not tilted with respect to the inner cover.

In one or more embodiments, the cover may further comprise a base secured to the tool outside the outer cover. The elastic member may be interposed between the base and the outer cover.

If the elastic member is located in the space between the outer cover and the inner cover, that is, inside the suction path, dust contained in the suctioned air may adhere to the elastic member and affect the behavior of the elastic member. In the above configuration, the elastic member is located outside the suction path. Thus, it is possible to prevent dust contained in the suctioned air from adhering to the elastic member.

In one or more embodiments, one of the outer cover and the base may include a guide pin. Other of the outer cover and the base may include a guide hole into which the guide pin is inserted.

The above configuration can limit a movable range of the outer cover with respect to the tool.

In one or more embodiments, the elastic member may be a compression spring attached to the guide pin.

In the above configuration, there is no need to additionally provide a mechanism for holding the elastic member between the base and the outer cover, thus it is possible to realize reduction in the number of components.

In one or more embodiments, the one of the outer cover and the base may include a plurality of guide pins. The other of the outer cover and the base may include a plurality of guide holes. The guide pins may be arranged circumferentially about a rotation axis of the tip tool. The guide holes may be arranged circumferentially about the rotation axis of the tip tool, corresponding to the guide pins.

The above configuration can reliably limit the movable range of the outer cover with respect to the tool.

In one or more embodiments, the inner cover may include a stopper projecting toward the outer cover. The outer cover may be pressed against the stopper by the elastic restoring force of the elastic member when an external force is not applied to the outer cover.

In the above configuration, even when no external force is applied to the outer cover, the stopper ensures a space between the outer cover and the inner cover. Therefore, it is possible to prevent the suction path from being occluded.

In one or more embodiments, the outer cover may include an outer cover body having an opening and a nozzle integrally formed with the outer cover body. The inner cover may include a flat plate portion and a cylindrical portion bending from an outer end of the flat plate portion. The flat plate portion of the inner cover may be secured to the base by a fastener with the cylindrical portion of the inner cover inserted in the opening of the outer cover.

According to the above configuration, the inner cover disposed inside the outer over can be secured to the base disposed outside the outer cover by a simple configuration.

### EMBODIMENTS

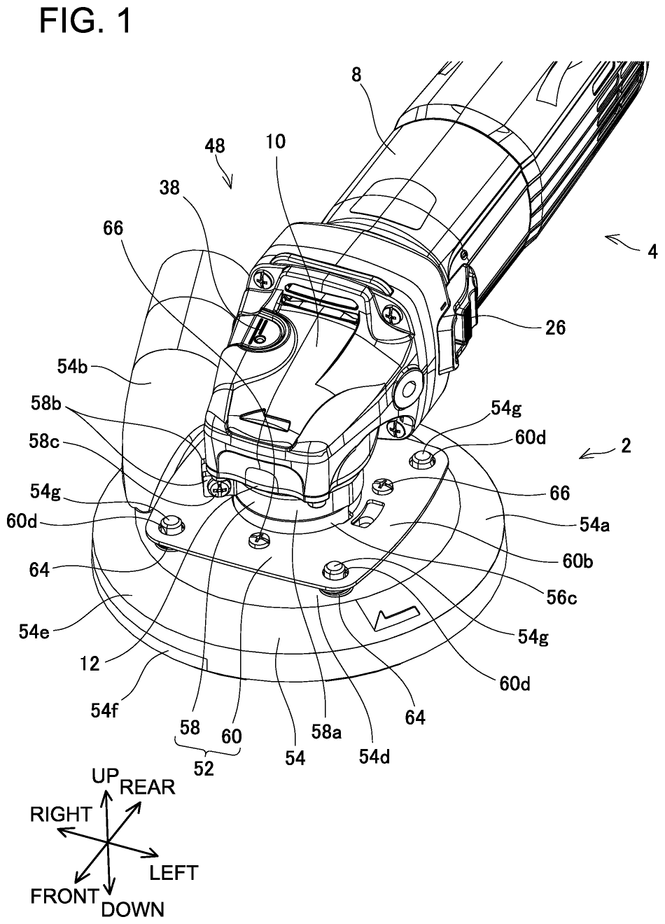

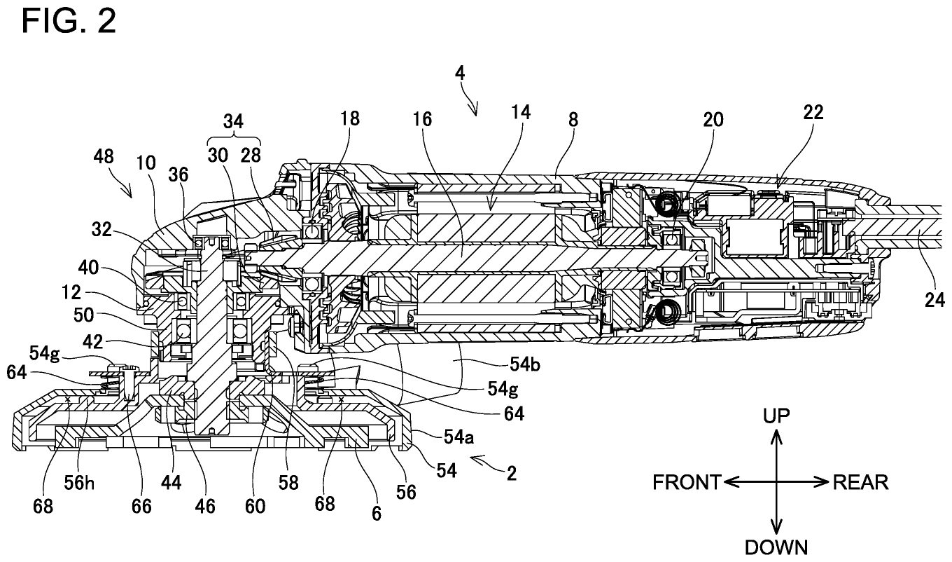

As shown in FIG. 1, a dust collecting cover 2 according to an embodiment is used while attached to a grinder 4. The grinder 4 can grind a workpiece, such as concrete, a block, a brick, and a stone, by rotation of a diamond cup wheel 6 (see FIG. 2). In the following description, a longitudinal direction of the grinder 4 will be referred as a front-rear direction, a rotation axis direction of the diamond cup wheel 6 will be referred to as an up-down direction, and a direction orthogonal to the front-rear direction and the up-down direction will be referred to as a right-left direction.

As shown in FIG. 2, the grinder 4 includes a body housing 8, a gear housing 10, and a bearing box 12.

A motor 14 is housed inside a front portion of the body housing 8. The motor 14 includes an output shaft 16 extending in the front-rear direction. The output shaft 16 is rotatably supported by the body housing 8 via bearings 18 and 20. A power circuit 22 is housed inside a rear portion of the body housing 8. Power is supplied to the power circuit 22 from an external power source through a power cable 24, The power circuit 22 supplies power to the motor 14 when a user operates a switch 26 (see FIG. 1, etc.) to ON, while it stops supplying power to the motor 14 when the user operates the switch 26 to OFF. The motor 14 rotates the output shaft 16 by the power supplied from the power circuit 22.

The gear housing 10 is attached to the front portion of the body housing 8. A first bevel gear 28 and a second bevel gear 30, which are configured to mesh with each other, are housed inside the gear housing 10. The first bevel gear 28 is secured to a front end of the output shaft 16. The second bevel gear 30 is secured to an upper end of a spindle 32 extending in the up-down direction. Hereinafter, the first bevel gear 28 and the second bevel gear 30 may be collectively referred to simply as bevel gear 34. The bevel gear 34 is a reduction mechanism configured to reduce the rotational speed of the motor 14 and transmit it to the spindle 32, thus it can be considered as a power transmission mechanism. The gear housing 10 supports the upper end of the spindle 32 via a bearing 36 such that the spindle 32 is rotatable. As shown in FIG. 1, a shaft lock 38 is disposed at an upper surface of the gear housing 10. When the user pushes the shaft lock 38 downward, the rotation of the second bevel gear 30 is thereby inhibited, as a result of which the rotation of the spindle 32 is inhibited.

As shown in FIG. 2, the bearing box 12 is attached to a lower portion of the gear housing 10. The bearing box 12 supports the spindle 32 via bearings 40 and 42 such that the spindle 32 is rotatable. The spindle 32 is rotatable with respect to the bearing box 12 about its rotation axis extending along the up-down direction. The diamond cup wheel 6 can be attached to a lower end of the spindle 32 via an inner flange 44 and an outer flange 46. The inner flange 44 is fitted to the spindle 32. The diamond cup wheel 6 is attached to the spindle 32 from below the inner flange 44 and is fitted to the inner flange 44. The outer flange 46 is screwed onto the spindle 32 from the lower end of the spindle 32 and sandwiches the diamond cup wheel 6 with the inner flange 44. The rotation of the motor 14 of the grinder 4 causes the spindle 32 and the diamond cup wheel 6 to rotate about the rotation axis, by which a workpiece is grinded. The spindle 32 can be referred to as a tip tool holder configured to hold the diamond cup wheel 6, which is a tip tool. In the following description, the body housing 8, the gear housing 10, and the bearing box 12 may be collectively referred to simply as housing 48.

The dust collecting cover 2 is attached to a substantially cylindrical cover mounting portion 50 of the bearing box 12. The dust collecting cover 2 has a shape that covers the periphery of the diamond cup wheel 6 when it is attached to the grinder 4. In other words, the dust collecting cover 2 has a shape that covers the periphery of the spindle 32 when it is attached. to the grinder 4. The dust collecting cover 2 prevents chips from scattering around while the diamond cup wheel 6 grinds a workpiece, and is used to collect the chips by a dust collector (not shown).

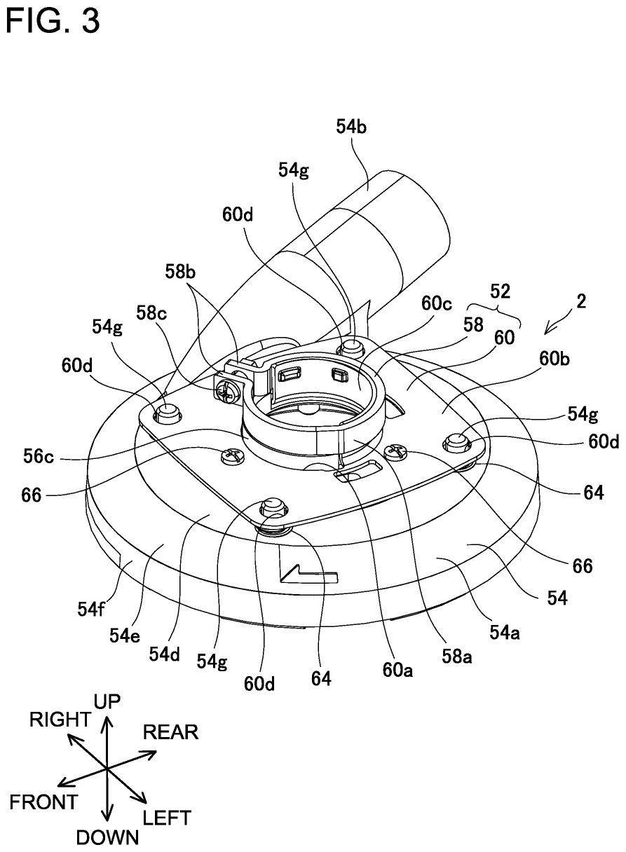

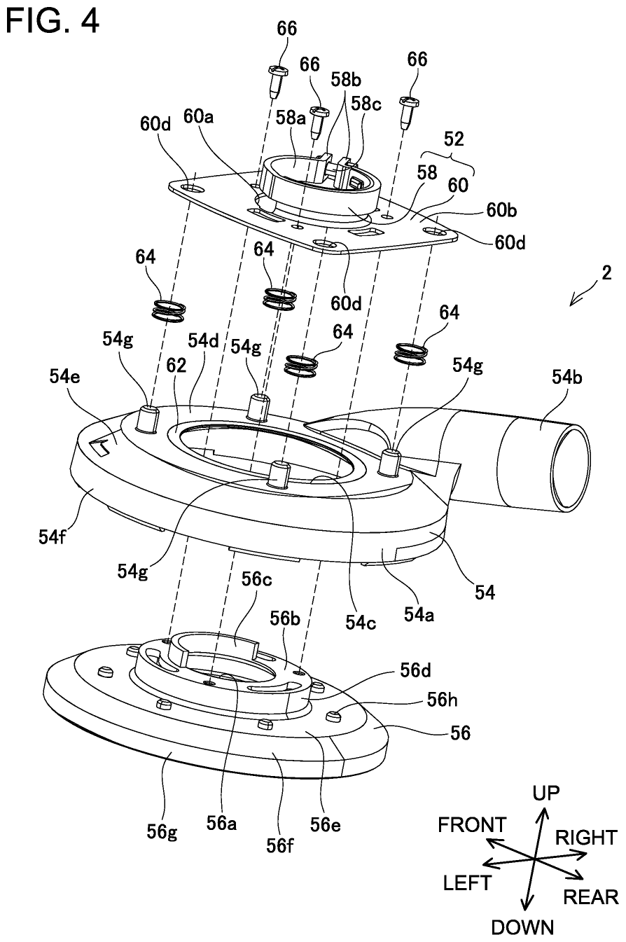

As shown in FIGS. 3 and 4, the dust collecting cover 2 includes a base 52, an outer cover 54, and an inner cover 56.

The base 52 includes a band 58 and a base plate 60. The band 58 includes a curved portion 58a that is formed by curving a belt-shaped flat plate into a cylindrical shape, a pair of flat plate portions 58b that extend outward respectively from both ends of the curved portion 58a, a fastener 58c for adjusting a space between the flat plate portions 58b. The base plate 60 includes a substantially square-shaped flat plate portion 60b having a substantially circular opening 60a, and a semi-cylindrical portion 60c that has a semi-cylindrical shape and bends upward along the edge of the opening 60a. A guide hole 60d are disposed near each of the four corners of the flat plate portion 60b. The band 58 and the base plate 60 are secured to each other by welding an outer surface of the semi-cylindrical portion 60c to an inner surface of the curved portion 58a. When the dust collecting cover 2 is to be secured to the bearing box 12, the band 58 is firstly expanded by loosening the fastener 58c and is attached to an outer surface of the cover mounting portion 50 of the bearing box 12, and then the band 58 is shrunken by tightening the fastener 58c.

The outer cover 54 includes an outer cover body 54a and a nozzle 54b. The outer cover body 54a and the nozzle 54b are formed integrally. As shown in FIG. 4, the outer cover body 54a includes a flat plate portion 54d having a substantially circular opening 54c, a truncated cone portion 54e that bends outward and downward from the outer end of the flat plate portion 54d, and a cylindrical portion 54f that has a substantially cylindrical shape and bends downward from the outer end of the truncated cone portion 54e. A substantially annular sealing member 62 constituted of an elastic material is disposed at the opening 54c. Four guide pins 54g projecting upward are disposed on an upper surface of the flat plate portion 54d. The guide pins 54g are located corresponding to the guide holes 60d of the base 52. The outer diameter of each guide pin 54g is smaller than the inner diameter of the corresponding guide hole 60d of the base 52. Thus, in a state where the guide pins 54g are through the guide holes 60d of the base 52, space is present between outer surfaces of the guide pins 54g and inner surfaces of the guide holes 60d. Therefore, in the state where the guide pins 54g are through the guide holes 60d, the outer cover 54 is inhibited to rotate about the rotation axis of the spindle 32 with respect to the base 52, but is allowed to move in the up-down direction and tilt in the front-rear direction and in the right-left direction. A compression spring 64 is attached to each guide pin 54g. The compression springs 64 are in contact with a lower surface of the flat plate portion 60b of the base 52 and the upper surface of the flat plate portion 54d of the outer cover 54. The compression springs 64 bias the outer cover 54 downward with respect to the base 52. A dust collecting brush (not shown) can be detachably attached to a lower end of the cylindrical portion 54f. An inner space of the nozzle 54b communicates with an inner space of the outer cover body 54a. A hose (not shown) extending from the dust collector (not shown) can be attached to the nozzle 54b.

The inner cover 56 includes a substantially circular first flat plate portion 56b having a substantially circular opening 56a, a semi-cylindrical portion 56c that has a semi-cylindrical shape and bends upward along the edge of the opening 56a, a first cylindrical portion 56d that bends downward from the outer end of the first flat plate portion 56b, a substantially circular second flat plate portion 56e that bends outward from a lower end of the first cylindrical portion 56d, a truncated cone portion 56f that bends outward and downward from the outer end of the second flat plate portion 56e, and a cylindrical portion 56g that has a substantially cylindrical shape and bends downward from the outer end of the truncated cone portion 56f. A plurality of stopper pins 56h protruding upward is disposed on an upper surface of the second flat plate portion 56e of the inner cover 56. The inner cover 56 is secured to the base 52 by fasteners 66 with the first cylindrical portion 566 inserted in the opening 54c of the outer cover 54. The fasteners 66 fasten the flat plate portion 60b of the base 52 and the first flat plate portion 56b of the inner cover 56 with each other. The first cylindrical portion 566 is slidable with respect to the sealing member 62 of the outer cover 54. As shown in FIG, 3, when the inner cover 56 is attached to the base 52, the semi-cylindrical portion 56c of the inner cover 56 passes through the opening 60a of the base 52 and fills a gap between the band 58 and the flat plate portion 60h.

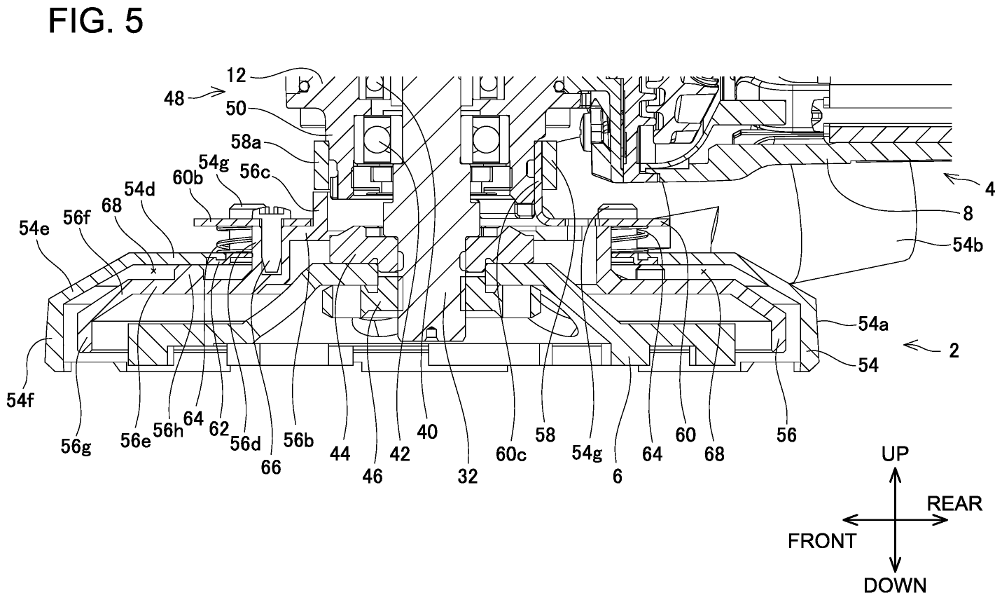

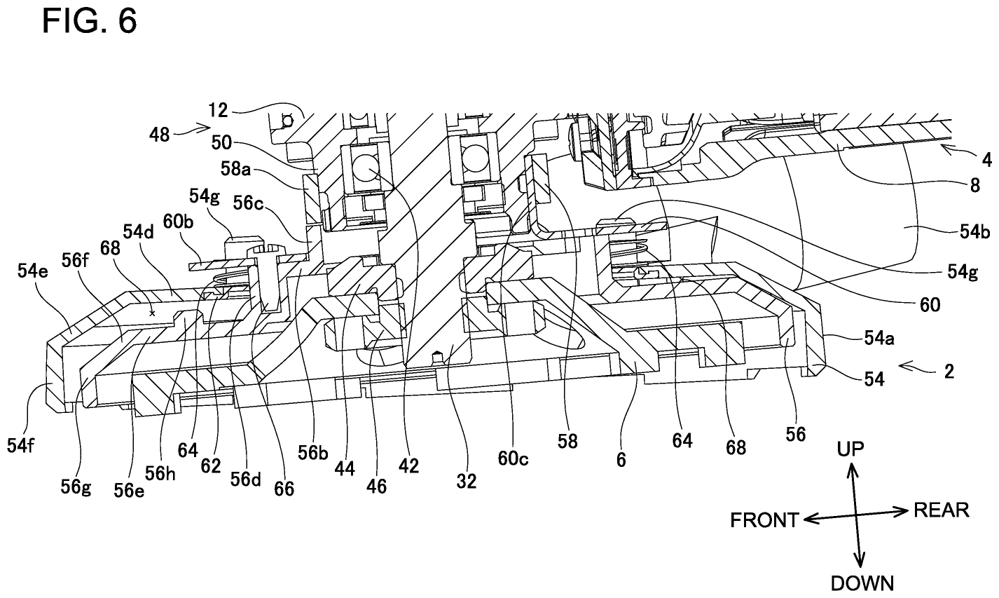

As shown in FIGS. 5 and 6, the inner cover 56 has a shape that covers an upper portion of the diamond cup wheel 6 when the dust collecting cover 2 is attached to the grinder 4. The outer cover 54 has a shape that covers an upper portion of the inner cover 56.

As shown in FIG. 5, when no external force is applied to the dust collecting cover 2, the outer cover 54 is pushed downward, by the biasing force of the compression springs 64, such that the lower surface of the flat plate portion 54d is in contact with the stopper pins 56h of the inner cover 56. In the dust collecting cover 2, a space between an inner surface of the outer cover 54 and an outer surface of the inner cover 56 constitutes a suction path 68 that communicates with the inner space of the nozzle 54b. Chips generated by the diamond cup wheel 6 grinding a workpiece reach the nozzle 54b with the flow of suctioned air flowing through the suction path 68 and are collected into the dust collector (not shown) through the hose (not shown) connected to the nozzle 54b.

As shown in FIG. 5, when no external force is applied to the outer cover 54, the lower surface of the flat plate portion 54d is in contact with all the stopper pins 56h of the inner cover 56, and the outer cover 54 is not tilted with respect to the inner cover 56. In this state, the width between the inner surface of the outer cover 54 and the outer surface of the inner cover 56, that is, the width of the suction path 68 is approximately equal circumferentially. this case, flow resistance of the suction path 68 is approximately equal circumferentially, thus the flow rate of suctioned air caused by the dust collector (not shown) is also approximately equal circumferentially. Therefore, chips generated by the diamond cup wheel 6 grinding a workpiece can be almost uniformly suctioned circumferentially.

As shown in FIG. 6, for example, when the grinder 4 is held obliquely to a workpiece with a front end of the outer cover 54 pressed against the workpiece, a front portion of the outer cover 54 is pushed upward against the biasing force of the compression springs 64. Since a rear portion of the outer cover 54 is still pushed downward by the biasing force of the other compression springs 64, the outer cover 54 is tilted in the front-rear direction with respect to the inner cover 56. In this case, in the front portion of the dust collecting cover 2, the width between the inner surface of the outer cover 54 and the outer surface of the inner cover 56 is widened, while in the rear portion of the dust collecting cover 2, the width between the inner surface of the outer cover 54 and the outer surface of the inner cover 56 is narrowed.

Therefore, in the front portion of the dust collecting cover 2, the flow resistance of the suction path 66 is reduced due to the width of the suction path 68 being widened. On the contrary, in the rear portion of the dust collecting cover 2, the flow resistance of the suction path 68 is increased due to the width of the suction path 68 being narrowed. Therefore, the flow rate of suctioned air caused by the dust collector (not shown) is large at a part of the suction path 68 in the front portion of the dust collecting cover 2, while it is small in a part of the suction path 68 in the rear portion of the dust collecting cover 2. As such, the suction force of the suctioned air can be locally increased in the front portion of the dust collecting cover 2. When the grinder 4 is held obliquely to the workpiece as shown in FIG. 6, a front end of the diamond cup wheel 6 contacts the workpiece, thus a large amount of chips is generated around the front portion of the dust collecting cover 2. The above-described configuration can locally increase the suction force of the suctioned air near a portion where chips are generated in a large amount, efficiently collecting the chips.

With reference to FIG. 6, the state where the front end of the outer cover 54 is pushed upward has been described, however, other than that, the rear end, a right end, a left end, or any circumferential position of the outer cover 54 can be pushed upward. At a portion where the outer cover 54 is pushed upward, the width of the suction path 68 is widened and the flow resistance of the suction path 68 is reduced, while at the opposite portion, the width of the suction path 68 is narrowed and the flow resistance of the suction path 68 is increased. In this case, the suction force of suctioned air is locally increased near the portion where the outer cover 54 is pushed upward, facilitating suction of chips.

Alternatively, the user may grasp the outer cover 54 and move the outer cover 54 upward with respect to the inner cover 56, without tilting the outer cover 54 with respect to the inner cover 56. In this case, the width of the suction path 68 is widened at all circumferential positions, thus the flow resistance of the suction path 68 is reduced. As a result, the flow rate of suctioned air caused by the dust collector (not shown) can be increased overall in the dust collecting cover 2.

As described above, in one or more embodiments, the dust collecting cover 2 (example of the cover) is used in the grinder 4 (example of the tool) with the diamond cup wheel 6 (example of the tip tool). The dust collecting cover 2 comprises the inner cover 56 covering at least a part of the diamond cup wheel 6 and the outer cover 54 covering at least a part of the inner cover 56. In the dust collecting cover 2, the space between the inner cover 56 and the outer cover 54 constitutes the suction path 68 through which suctioned air flows. In the dust collecting cover 2, the shape of the suction path 68 is changeable by a change in the relative positional relationship between the inner cover 56 and the outer cover 54.

In one or more embodiments, the grinder 4 (example of the tool) comprises the motor 14 (example of the prime mover), the bevel gear 34 (example of the power transmission mechanism) connected to the motor 14, the housing 48 that houses the motor 14 and the bevel gear 34, the spindle 32 (example of the tip tool holder) configured to hold the diamond cup wheel 6 and connected to the bevel gear 34, and the dust collecting cover 2 (example of the cover). The dust collecting cover 2 includes the inner cover 56 covering at least a part of the diamond cup wheel 6 and the outer cover 54 covering at least a part of the inner cover 56. In the grinder 4, the space between the inner cover 56 and the outer cover 54 constitutes the suction path 68 through which suctioned air flows. In the grinder 4, the shape of the suction path 68 is changeable by a change in the relative positional relationship between the inner cover 56 and the outer cover 54.

In the dust collecting cover 2 and the grinder 4 described above, the shape of the suction path 68 through which suctioned air flows can be changed by changing the relative positional relationship between the inner cover 56 and the outer cover 54, thereby the flow resistance of the suction path 68 can be changed. As a result, it is possible to adjust the suction force of the suctioned air in the dust collecting cover 2.

In one or more embodiments, the outer cover 54 is tiltable in the front-rear direction (example of the first direction) with respect to the inner cover 56.

For example, when the outer cover 54 is tilted in the front-rear direction with respect to the inner cover 56 such that the front end of the outer cover 54 is farther from the inner cover 56 and the rear end of the outer cover 54 is closer to the inner cover 56, the suction path 68 becomes wider near the front end of the outer cover 54 as compared to near the rear end of the outer cover 54, and the flow resistance of the suction path 68 becomes lower. As such, the suction force near the front end of the outer cover 54 can be increased as compared to the suction force near the rear end of the outer cover 54. The above configuration can locally increase the suction force of the suctioned air in the dust collecting cover 2.

In one or more embodiments, the outer cover 54 is tillable also in the right-left direction (example of the second direction orthogonal to the first direction) with respect to the inner cover 56.

In a configuration where the outer cover 54 is tillable with respect to the inner cover 56 in two directions orthogonal to each other, a position where the outer cover 54 is farthest from the inner cover 56 and the width of the suction path 68 is the widest, that is, a position Where the flow resistance of the suction path 68 is the lowest can be set to any circumferential position. The above configuration can increase the suction force at any circumferential position as compared to at other positions.

In one or more embodiments, the dust collecting cover 2 further comprises the compression springs 64 configured to bias the outer cover 54 by their elastic restoring force such that the tilt angle of the outer cover 54 with respect to the inner cover 56 is reduced when the outer cover 54 tilts with respect to the inner cover 56.

According to the above-described configuration, it is possible to automatically restore, by using the elastic restoring force of the compression springs 64, the suction force of suctioned air that has been changed by tilting the outer cover 54 with respect to the inner cover 56 to the suction force of suctioned air at when the outer cover 54 is not tilted with respect to the inner cover 56.

In one or more embodiments, the dust collecting cover 2 further comprises the base 52 secured to the grinder 4 outside the outer cover 54. The compression springs 64 are interposed between the base 52 and the outer cover 54.

In the above configuration, the compression springs 64 are located outside the suction path 68. Thus, it is possible to prevent dust contained in the auctioned air from adhering to the compression springs 64.

In one or more embodiments, one of the outer cover 54 and the base 52 (e.g., the outer cover 54) includes the guide pins 54g. The other of the outer cover 54 and the base 52 (e.g., the base 52) includes the guide holes 60d into which the guide pins 54g are inserted.

The above configuration can limit a movable range of the outer cover 54 with respect to the grinder 4.

In one or more embodiments, the compression springs 64 are attached to the guide pins 54g.

In the above configuration, there is no need to additionally provide a mechanism for holding the compression springs 64 between the base 52 and the outer cover 54, thus it is possible to realize reduction in the number of components.

In one or more embodiments, the one of the outer cover 54 and the base 52 (e.g., the outer cover 54) includes the plurality of guide pins 54g. The other of the outer cover 54 and the base 52 (e.g., the base 52) includes the plurality of guide holes 60d. The guide pins 54g are arranged circumferentially about the rotation axis of the diamond cup wheel 6. The guide holes 60d. arc arranged circumferentially about the rotation axis of the diamond cup wheel 6, corresponding to the guide pins 54g.

The above configuration can reliably limit the movable range of the outer cover 54 with respect to the grinder 4.

In one or more embodiments, the inner cover 56 includes the stopper pins 56h (example of the stopper) projecting toward the outer cover 54. The outer cover 54 is pressed against the stopper pins 56h by the elastic restoring force of the compression springs 64 when an external force is not applied to the outer cover 54.

In the above configuration, even when no external force is applied to the outer cover 54, the stopper pins 56h ensure a space between the outer cover 54 and the inner cover 56. Therefore, it is possible to prevent the suction path 68 from being occluded.

In one or more embodiments, the outer cover 54 includes the outer cover body 54a having the opening 54c and the nozzle 54b integrally formed with the outer cover body 54a. The inner cover 56 includes the first flat plate portion 56b (example of the flat plate portion) and the first cylindrical portion 56d (example of the cylindrical portion) bending from the outer end of the first flat plate portion 56b. The first flat plate portion 56b of the inner cover 56 is secured to the base 52 by the fasteners 66 with the first cylindrical portion 564 of the inner cover 56 inserted in the opening 54c of the outer cover 54.

According to the above configuration, the inner cover 56 disposed inside the outer cover 54 can be secured to the base 52 disposed outside the outer cover 54 by a simple configuration.

The embodiments described above exemplify that the tool is the grinder 4, the prime mover is the motor 14, the tip tool is the diamond cup wheel 6, the tip tool holder is the spindle 32, the cover is the dust collecting cover 2. However, the tool may be a tool of another type, the prime mover may be a prime mover of another type, the tip tool may be a tip tool of another type, the tip tool holder may be a tip tool holder of another type, and the cover may be a cover of another type. In the above embodiments, the grinder 4, which is a tool, is configured to operate by being supplied with AC power through the power cable 24. Unlike this, the grinder 4, which is a tool, may be configured to operate by being supplied with DC power from a battery attached to the body housing 8.

1. A cover for use in a tool with a tip tool, the cover comprising:
an inner cover covering at least a part of the tip tool; and
an outer cover covering at least a part of the inner cover,
wherein
a space between the inner cover and the outer cover constitutes a suction path through which suctioned air flows, and
a shape of the suction path is changeable by a change in a relative positional relationship between the inner cover and the outer cover.

2. The cover according to claim 1, wherein the outer cover is tiltable in a first direction with respect to the inner cover.

3. The cover according to claim 2, wherein the outer cover is tiltable also in a second direction orthogonal to the first direction with respect to the inner cover.

4. The cover according to claim 2, further comprising an elastic member configured to bias the outer cover to reduce a tilt angle of the outer cover with respect to the inner cover by an elastic restoring force when the outer cover tilts with respect to the inner cover.

5. The cover according to claim 4, further comprising a base secured to the tool outside the outer cover,
wherein the elastic member is interposed between the base and the outer cover.

6. The cover according to claim 5, wherein
one of the outer cover and the base includes a guide pin, and
other of the outer cover and the base includes a guide hole into which the guide pin is inserted.

7. The cover according to claim 6, wherein the elastic member is a compression spring attached to the guide pin.

8. The cover according to claim 6, wherein
the one of the outer cover and the base includes a plurality of guide pins,
the other of the outer cover and the base includes a plurality of guide holes,
the guide pins are arranged circumferentially about a rotation axis of the tip tool, and
the guide holes are arranged circumferentially about the rotation axis of the tip tool, corresponding to the guide pins.

9. The cover according to claim 5, wherein
the inner cover includes a stopper projecting toward the outer cover, and
the outer cover is pressed against the stopper by the elastic restoring force of the elastic member when an external force is not applied to the outer cover.

10. The cover according to claim 5, wherein
the outer cover includes an outer cover body having an opening and a nozzle integrally formed with the outer cover body,
the inner cover includes a flat plate portion and a cylindrical portion bending from an outer end of the flat plate portion, and
the flat plate portion of the inner cover is secured to the base by a fastener with the cylindrical portion of the inner cover inserted in the opening of the outer cover.

11. A tool comprising:
a prime mover;
a power transmission mechanism connected to the prime mover;
a housing that houses the prime mover and the power transmission mechanism;
a tip tool holder configured to hold a tip tool and connected to the power transmission mechanism; and
a cover,
wherein
the cover includes:
an inner cover covering at least a part of the tip tool; and
an outer cover covering at least a part of the inner cover,
a space between the inner cover and the outer cover constitutes a suction path through which suctioned air flows, and
a shape of the suction path is changeable by a change in a relative positional relationship between the inner cover and the outer cover.

12. The cover according to claim 3, further comprising:
an elastic member configured to bias the outer cover to reduce a tilt angle of the outer cover with respect to the inner cover by an elastic restoring force when the outer cover tilts with respect to the inner cover; and
a base secured to the tool outside the outer cover,
wherein
the elastic member is interposed between the base and the outer cover,
the one of the outer cover and the base includes a plurality of guide pins,
the other of the outer cover and the base includes a plurality of guide holes into which the guide pins are inserted,
the elastic member includes a plurality of compression springs attached to the guide pins,
the guide pins are arranged circumferentially about a rotation axis of the tip tool,
the guide holes are arranged circumferentially about the rotation axis of the tip tool, corresponding to the guide pins,
the inner cover includes a stopper projecting toward the outer cover,
the outer cover is pressed against the stopper by the elastic restoring force of the elastic member when an external force is not applied to the outer cover,
the outer cover further includes an outer cover body having an opening and a nozzle integrally formed with the outer cover body,
the inner cover further includes a flat plate portion and a cylindrical portion bending from an outer end of the flat plate portion, and
the flat plate portion of the inner cover is secured to the base by a fastener with the cylindrical portion of the inner cover inserted in the opening of the outer cover.
